(19) United States
(12) Patent Application Publication
(10) Pub. No.: US 2025/0226516 A1
(43) Pub. Date: Jul. 10, 2025

(54) Battery Assembly

(71) Applicant: LG Energy Solution, Ltd., Seoul (KR)

(72) Inventors: Won-Sik Chung, Daejeon (KR); Min-Sung Kim, Daejeon (KR)

(73) Assignee: LG Energy Solution, Ltd., Seoul (KR)

(21) Appl. No.: 19/007,862

(22) Filed: Jan. 2, 2025

(30) Foreign Application Priority Data
Jan. 4, 2024 (KR) 10-2024-0001775

(51) Int. Cl. H01M 50/264; H01M 50/211

(52) U.S. Cl. CPC H01M 50/264; H01M 50/211; H01M 2220/20

(57) ABSTRACT

A battery assembly includes a base plate; a resin layer disposed on an upper surface of the base plate; a battery cell located above the resin layer; and an insulating sheet located between the battery cell and the resin layer, the insulating sheet having a score line.

### CROSS-REFERENCE TO RELATED APPLICATIONS

This application claims priority to Korean Patent Application No. 10-2024-0001775, filed on Jan. 4, 2024, the disclosure of which is incorporated herein in its entirety by reference.

### TECHNICAL FIELD

The present disclosure relates to a battery assembly.

### BACKGROUND

As the demand for portable electronic products such as laptops, video cameras, and portable phones is rapidly increasing, and robots, electric vehicles, or the like are commercialized in earnest, research on high-performance secondary batteries capable of repeated charging and discharging is actively underway.

Currently, commercially available secondary batteries include nickel-cadmium batteries, nickel-hydrogen batteries, nickel-zinc batteries, lithium secondary batteries and the like, and among them, lithium secondary batteries have little or no memory effect, and thus they are gaining more attention than nickel-based secondary batteries for their advantages that recharging can be done whenever it is convenient, the self-discharge rate is very low and the energy density is high.

Lithium secondary batteries primarily comprise lithium-based oxides and carbon materials for a positive electrode active material and a negative electrode active material, respectively. A lithium secondary battery includes an electrode assembly including a positive electrode plate and a negative electrode plate coated with the positive electrode active material and the negative electrode active material, respectively, with a separator interposed between the positive electrode plate and the negative electrode plate, and a sealed packaging or battery case accommodating the electrode assembly together with an electrolyte solution.

In general, lithium secondary batteries may be classified into can-type secondary batteries in which the electrode assembly is included in a metal can and pouch-type secondary batteries in which the electrode assembly is included in a pouch of an aluminum laminate sheet, according to the shape of the battery case.

Recently, secondary batteries have been widely used in medium and large devices such as electric vehicles and energy storage systems (ESSs) for driving and storing energy, as well as in small devices such as portable electronic devices. A plurality of secondary batteries may be electrically connected and stored inside a module case, thereby forming a battery module. In addition, multiple battery modules may be connected to each other to form a battery pack.

However, if a plurality of secondary batteries (battery cells) or a plurality of battery modules are crowded in a small space, they may be vulnerable to thermal events. In particular, if an event such as thermal runaway occurs in one battery cell, high temperature gas, flame, or heat may be generated. If the gases, flames, heat, etc. is transferred to other battery cells included in the same battery module, an explosive chain reaction situation such as thermal propagation may occur. Also, this chain reaction not only causes accidents such as fire or explosion in the corresponding battery module, but may also cause fire or explosion in other battery modules.

Moreover, in the case of medium to large-sized battery packs such as electric vehicles, a large number of battery cells and battery modules are included to increase output and/or capacity, so the risk of thermal chain reaction may increase further. Furthermore, in the case of a battery pack mounted on an electric vehicle, etc., users such as drivers may be present nearby.

In particular, due to the swelling phenomenon in which the battery cell swells, the battery cell is easily physically damaged, and the risk of a thermal event occurring due to the damage to the battery cell may increase. Therefore, even if the swelling phenomenon occurs in the battery cell, it is necessary to suppress damage to the battery cell and reduce the risk of a thermal event occurring.

### SUMMARY

### Technical Problem

The present disclosure is designed to solve these and other problems.

The present disclosure is directed to providing a battery assembly with improved electrical safety.

The present disclosure is also directed to providing a battery assembly that may prevent damage to battery cells even when swelling occurs.

### Technical Solution

In one aspect of the present disclosure, there is provided a battery assembly comprising: a base plate; a resin layer disposed on an upper surface of the base plate; a battery cell located above the resin layer; and an insulating sheet located between the battery cell and the resin layer and having a score line.

In addition, the battery cell may be coupled to the insulating sheet.

In addition, a coupling force of the battery cell and the insulating sheet may be higher than a coupling force of the resin layer and the insulating sheet.

In addition, the score line may be located outside an area where the battery cell and the insulating sheet come into contact.

In addition, the battery cell may extend, and the score line may extend along an extension direction of the battery cell.

In addition, the score line may include a first region; and a second region having higher separability than the first region.

In addition, the score line may further include a third region having lower separability than the second region, and the second region may be located between the first region and the third region.

In addition, the battery cell may be provided in plurality, the plurality of battery cells may be stacked along one direction, and the score line may extend between two portions where two neighboring battery cells among the plurality of battery cells are in contact with the insulating sheet.

In addition, the score line may include a first score line extending along one direction; and a second score line opposite to the first score line, and the first score line may be configured to have higher separability than the second score line.

In addition, the second score line may be located closer to a center portion of the insulating sheet than the first score line.

A battery module according to one aspect of the present disclosure comprises the battery assembly of the present disclosure.

A battery pack according to one aspect of the present disclosure comprises the battery assembly of the present disclosure.

A vehicle according to another aspect of the present disclosure may include the battery assembly of the present disclosure.

### Advantageous Effects

According to at least one of the aspects of the present disclosure, the battery cell may be separated or moved together with the insulating sheet.

According to at least one of the aspects of the present disclosure, the electrical safety of the battery assembly may be improved.

According to at least one of the aspects of the present disclosure, damage to the battery cell may be prevented.

According to at least one of the aspects of the present disclosure, the service life of the battery assembly may be improved.

### BRIEF DESCRIPTION OF THE DRAWINGS

The accompanying drawings illustrate aspects of the present disclosure and together with the foregoing disclosure, serve to provide further understanding of the technical features of the present disclosure, and thus, the present disclosure is not construed as being limited to the drawings.

FIG. 1 is a drawing showing a battery assembly according to an aspect of the present disclosure in which some components are exploded.

FIG. 2 is a cross-sectional view showing the battery assembly of FIG. 1.

FIG. 3 is a drawing showing an insulating sheet of the battery assembly of FIG. 1.

FIG. 4 is a drawing showing a battery cell of the battery assembly of FIG. 1.

FIG. 5 is a drawing showing the separation of the insulating sheet of the battery assembly of FIG. 1.

FIG. 6 is a drawing showing a modified aspect of FIG. 3.

FIG. 7 is a drawing showing another modified aspect of FIG. 3.

FIG. 8 is a drawing showing still another modified aspect of FIG. 3.

FIG. 9 is a drawing showing a battery module according to an aspect of the present disclosure.

FIG. 10 is a drawing showing a battery module according to another aspect of the present disclosure.

FIG. 11 is a drawing showing a battery pack according to an aspect of the present disclosure.

### DETAILED DESCRIPTION

Hereinafter, aspects of the present disclosure will be described in detail with reference to the accompanying drawings. Prior to the description, it should be understood that the terms used in the disclosure and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just an example for the purpose of illustrations only, not intended to limit the scope of the disclosure, so it should be understood that other equivalents and modifications could be made thereto without departing from the scope of the disclosure.

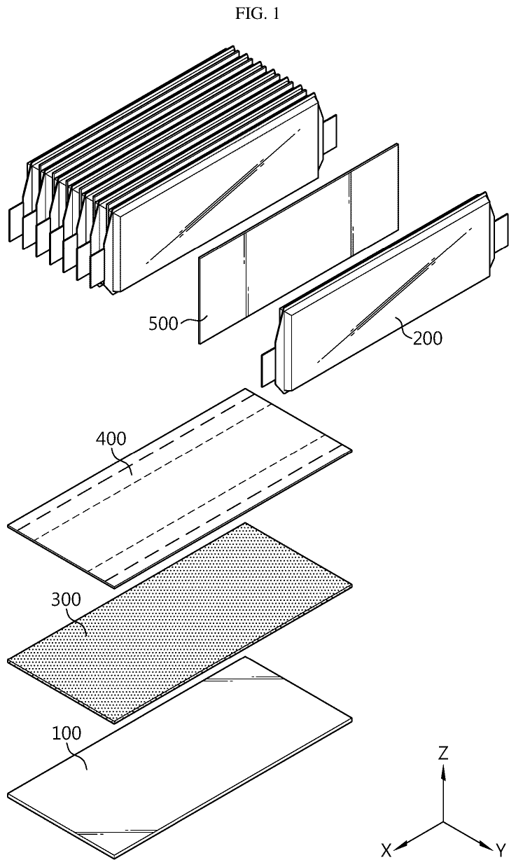

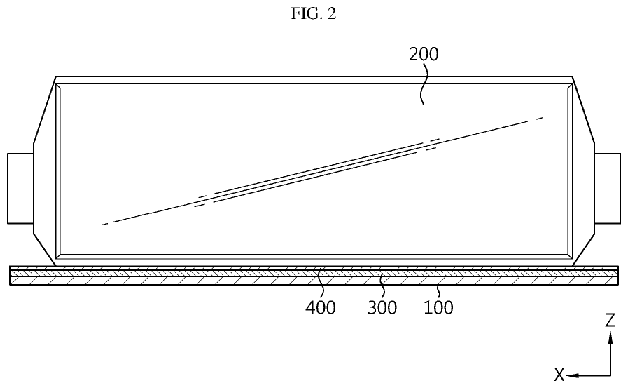

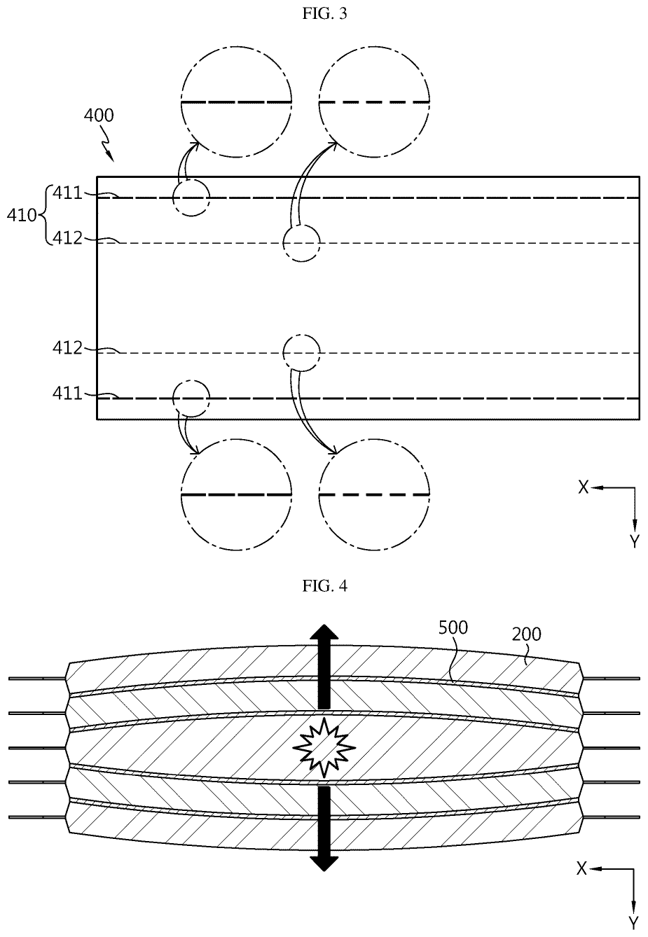

FIG. 1 is a drawing showing a battery assembly according to an aspect of the present disclosure in which some components are exploded. FIG. 2 is a cross-sectional view showing the battery assembly of FIG. 1. FIG. 3 is a drawing showing an insulating sheet 400 of the battery assembly of FIG. 1.

Referring to FIGS. 1 to 3, the battery assembly may include a base plate 100, a resin layer 300, a battery cell 200, and an insulating sheet 400.

The base plate 100 may have a flat plate shape. The base plate 100 may form an outer appearance of the battery assembly. In addition, the base plate 100 may function as a heatsink. In addition, the base plate 100 may additionally have a channel through which a cooling fluid may flow. In addition, the base plate 100 may additionally have a fin for heat dissipation.

The resin layer 300 may be arranged, located, or formed on the upper surface of the base plate 100. The resin layer 300 may contain a material having adhesive properties. Also, the resin layer 300 may be adhered, coupled, or fixed to the upper surface of the base plate 100. The resin layer 300 may contain a material having high thermal conductivity. In addition, the resin may contain a material having heat curing properties.

The battery cell 200 may be located above the resin layer 300. At this time, the battery cell 200 may mean a secondary battery. Also, the battery cell 200 may be a secondary battery having a pouch shape. The battery cell 200 may be provided in plurality. The plurality of battery cells 200 may be stacked along the left and right direction or the Y-axis direction.

A pad 500 may be located between the plurality of battery cells 200. The pad 500 may be provided in plurality. The pad 500 may contain an elastic material. For example, the pad 500 may contain a silicone material or a polyurethane material. The pad 500 may be compressed when the battery cell 200 swells.

The insulating sheet 400 may be located between the battery cell 200 and the resin layer 300. The insulating sheet 400 may contain an electrically insulating material. For example, the insulating sheet 400 may contain a polycarbonate material. In addition, the insulating sheet 400 may be made of a thin plate. For example, the insulating sheet 400 may have a thickness of 100 um to 250 um.

The insulating sheet 400 may be attached, coupled or fixed to the upper surface of the resin layer 300. Also, the insulating sheet 400 may be attached, coupled or fixed to the lower surface of the battery cell 200. An adhesive layer or adhesive member may be additionally provided between the insulating sheet 400 and the battery cell 200.

The insulating sheet 400 may have a score line 410. The score line 410 may be used as a term that includes and collectively refers to a perforated line 410, a notching line 410, a cutting line 410, a shredding line 410, a tear line 410, or a score line 410.

The score line 410 may allow the insulating sheet 400 to be easily separated by the shear stress applied to the insulating sheet 400.

According to this configuration of the present disclosure, the stability and safety of the battery assembly may be improved. The battery cell 200 may be separated together with the insulating sheet 400. When swelling occurs in some of the battery cells 200 among the plurality of battery cells 200 that are stacked, neighboring battery cells 200 may receive force in the stacking direction. As a result, some of the battery cells 200 may be separated together with a part of the insulating sheet 400. For example, when the battery cell 200 is not separated because it is coupled with the insulating sheet 400 or the resin layer 300, the lower surface of the battery cell 200 may be torn or damaged by the force received in the stacking direction. However, according to this configuration of the present disclosure, since the battery cell 200 is allowed to be separated, moved, or detached together with the insulating sheet 400, the battery cell 200 may be prevented from being damaged. As a result, the lifespan of the battery assembly may be improved, and the cooling performance may be maintained.

Referring to FIGS. 1 to 3, the coupling force of the battery cell 200 and the insulating sheet 400 of the battery assembly according to an aspect of the present disclosure may be higher than the coupling force of the resin layer 300 and the insulating sheet 400. Alternatively, the coupling of the resin layer 300 and the insulating sheet 400 may be separated more easily than the coupling of the battery cell 200 and the insulating sheet 400. Accordingly, when the battery cell 200 is subjected to shear stress due to swelling, the battery cell 200 and the insulating sheet 400 may not be separated, but the insulating sheet 400 may move on the resin layer 300. At this time, the insulating sheet 400 may be separated at least partially along the score line 410.

According to this configuration of the present disclosure, since the battery cell 200 is configured to be movable, damage to the battery cell 200 may be minimized. As a result, the lifespan, safety, and stability of the battery assembly may be improved.

Referring to FIGS. 1 to 3, the battery cell 200 of the battery assembly according to an aspect of the present disclosure may extend long. The battery cell 200 may extend long along the longitudinal direction or the X-axis direction. Also, a score line 410 may extend long along the battery cell 200. Alternatively, the score line 410 may extend long along the front and rear direction, the longitudinal direction of the battery cell 200, or the X-axis direction.

According to this configuration of the present disclosure, the score line 410 may facilitate movement or separation of the battery cell 200.

Referring to FIGS. 1 to 3, the battery assembly according to an aspect of the present disclosure may have a plurality of score lines 410. The score lines 410 may include a first score line 411 and a second score line 412. The first score line 411 may extend along one direction. The first score line 411 may extend along the front and rear direction or the X-axis direction. The second score line 412 may be opposite to the first score line 411. The second score line 412 may extend along the front and rear direction, the X-axis direction, or the longitudinal direction of the first score line 411.

The first score line 411 may be configured to have higher separability than the second score line 412. Separability may mean the degree to which the insulating sheet 400 is easily separated. High separability may mean that the insulating sheet 400 can be easily separated.

According to this configuration of the present disclosure, since the battery cell 200 is configured to be movable, damage to the battery cell 200 may be minimized. When swelling occurs in the plurality of stacked battery cells 200, shear stress may be applied to the battery cell 200. Also, displacement due to swelling may accumulate along the stacking direction. Due to this, among the plurality of stacked battery cells 200, the battery cell 200 located at the outer side needs to be more easily separated and may have to move more than the battery cell 200 located at the inner side. Therefore, by configuring each score line 410 to have different separability, damage according to the location of the battery cell 200 may be prevented.

Referring to FIGS. 1 to 3, the second score line 412 of the battery assembly according to an aspect of the present disclosure may be located closer to a center portion of the insulating sheet 400 than the first score line 411. Alternatively, the second score line 412 may be located more inward than the first score line 411. Alternatively, the first score line 411 may be located more outward than the second score line 412.

The first score line 411 may be provided as a pair. Also, the second score line 412 may be provided as a pair. The pair of second score lines 412 may be located between the pair of first score lines 411.

According to this configuration of the present disclosure, since the first score line 411, which has high separability, is located outside the second score line 412, the first score line 411 may be easily separated or moved depending on the location of the battery cell 200. As a result, damage to the battery cell 200 may be prevented regardless of the location of the battery cell 200.

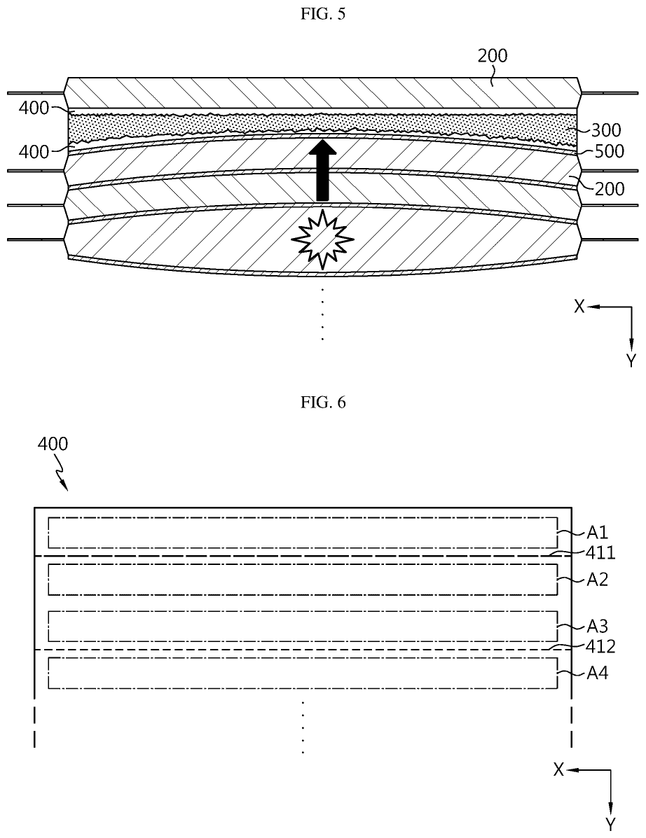

FIG. 4 is a drawing showing a battery cell 200 of the battery assembly of FIG. 1. FIG. 5 is a drawing showing the separation of the insulating sheet 400 of the battery assembly of FIG. 1. Referring to FIGS. 4 and 5, swelling may occur in the battery cell 200 of the battery assembly according to an aspect of the present disclosure. The battery cell 200 in which swelling has occurred may expand along the left and right direction or the Y-axis direction. Accordingly, the battery cell 200 may be moved or separated together with the insulating sheet 400. At this time, the moved or separated battery cell 200 may be a battery cell 200 located at the outermost end among the plurality of stacked battery cells 200.

FIG. 6 is a drawing showing a modified aspect of FIG. 3. Referring to FIGS. 4 to 6, the score lines 411 and 412 of the battery assembly according to an aspect of the present disclosure may be located outside an area where the battery cell 200 and the insulating sheet 400 are in contact, coupled, attached or fixed. The lower surface of the battery cell 200 may be in contact, coupled, attached or fixed to the upper surface of the insulating sheet 400. At this time, portions of the insulating sheet 400 that are in contact, coupled, attached or fixed to the battery cell 200 may be indicated as A1, A2, A3 and A4. In addition, the score lines 411 and 412 may be located outside the portions A1, A2, A3 and A4. Alternatively, the score lines 411 and 412 may not meet or intersect the portions A1, A2, A3 and A4.

If the score lines 411 and 412 overlap with the portions A1, A2, A3, and A4, damage to the battery cell 200 may occur when the insulating sheet 400 is separated.

However, according to this configuration of the present disclosure, the insulating sheet 400 may be separated at the boundary of neighboring battery cells 200. As a result, damage to the battery cells 200 may be prevented.

Referring to FIGS. 4 to 6, the score lines 411 and 412 of the battery assembly according to an aspect of the present disclosure may extend between two portions where two neighboring battery cells 200 are in contact with the insulating sheet 400.

The first score line 411 may be located between A1 and A2. The first score line 411 may extend along at least one of the longitudinal direction of A1, the longitudinal direction of A2, between A1 and A2, the front and rear direction, or the X-axis direction. At this time, the battery cell 200 that is in contact with, coupled, attached, or fixed to the A1 portion may be the battery cell 200 that is located at the outermost side among the plurality of stacked battery cells 200.

The second score line 412 may be located between A3 and A4. The second score line 412 may extend along at least one of the longitudinal direction of A3, the longitudinal direction of A4, between A3 and A4, the front and rear direction, or the X-axis direction. At this time, the battery cell 200 that is in contact with, coupled, attached, or fixed to the A3 or A4 portion may be the battery cell 200 that is located in the middle portion or close to the middle portion among the plurality of stacked battery cells 200.

According to this configuration of the present disclosure, the insulating sheet 400 may be separated at the boundary of the neighboring battery cells 200. As a result, damage to the battery cell 200 may be prevented. In addition, since the first score line 411 having high separability is located outside the second score line 412, separation or movement according to the position of the battery cell 200 may be facilitated.

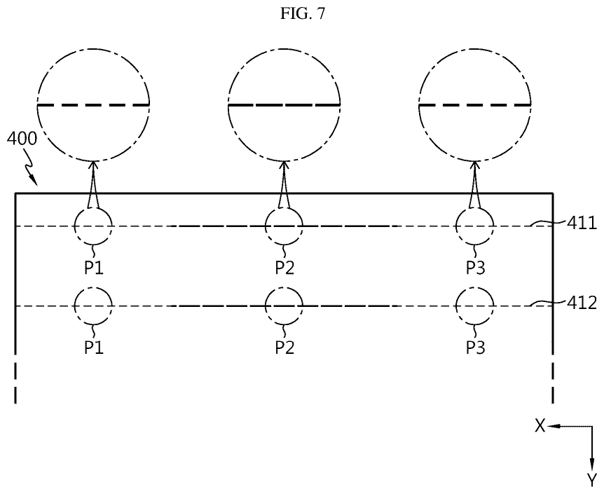

FIG. 7 is a drawing showing another modified aspect of FIG. 3. Referring to FIG. 7, the score lines 411 and 412 of the battery assembly according to an aspect of the present disclosure may include a first region P1 and a second region P2. The separability of the second region P2 may be higher than the separability of the first region P1. The first region P1 and the second region P2 may be connected continuously. Also, the second region P2 may be located in the center portion or close to the center portion of the score lines 411 and 412.

According to this configuration of the present disclosure, damage to the battery cell 200 may be prevented. When swelling occurs in the battery cell 200, the center portion of the battery cell 200 may primarily expand. Accordingly, in the score lines 411 and 412, the portion corresponding to the center portion of the battery cell 200 has higher separability than the other portion, so that the battery cell 200 may be easily separated or moved.

Referring to FIG. 7, the score line 410 of the battery assembly according to an aspect of the present disclosure may further include a third region P3. The third region P3 may have lower separability than the second region P2. Also, the second region P2 may be located between the first region P1 and the third region P3. The first region P1, the second region P2, and the third region P3 may be connected continuously. In addition, the separability of the first region P1 and the separability of the third region P3 may be substantially the same.

The first region P1 and the third region P3 may be located and configured symmetrically with respect to the second region P2. Also, the second region P2 may be located in the center portion or close to the center portion of the score lines 411 and 412.

According to this configuration of the present disclosure, the battery cell 200 may be easily separated or moved.

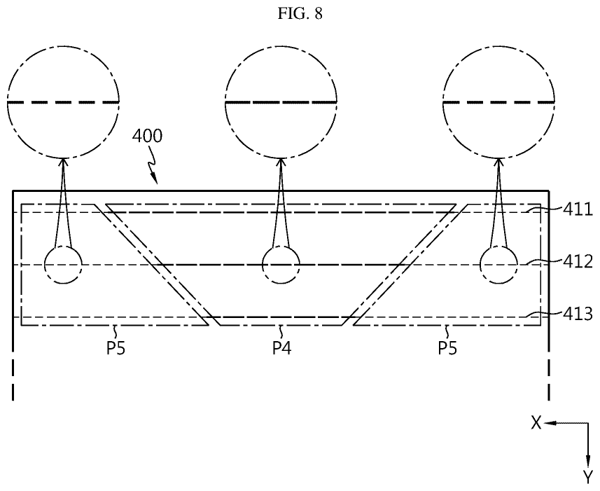

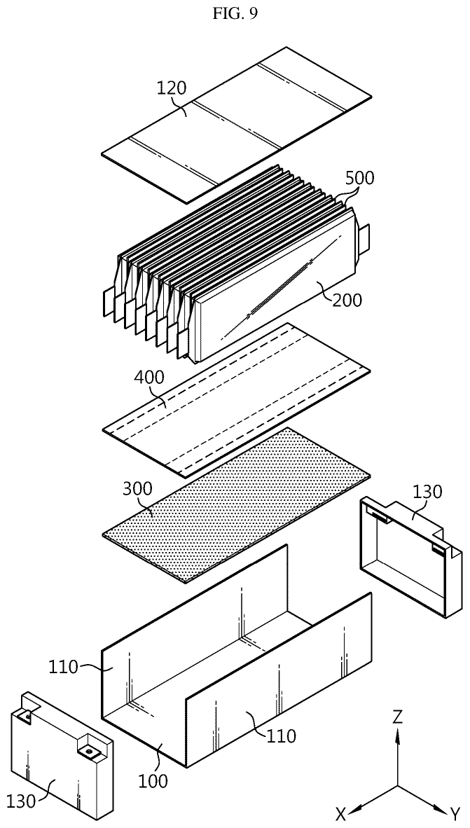

FIG. 8 is a drawing showing still another modified aspect of FIG. 3. Referring to FIG. 8, the score lines 411, 412, and 413 of the battery assembly according to an aspect of the present disclosure may include a first score line 411, a second score line 412, and a third score line 413. The first score line 411 may be located at the outermost side. Also, the second score line 412 may be located more inward than the first score line 411. Also, the third score line 413 may be located more inward than the second score line 412. The first score line 411 to the third score line 413 may include a fourth region P4 and a fifth region P5. The fifth region P5 may have lower separability than the fourth region P4. Also, the fourth region P4 may be located between a pair of fifth regions P5. The fourth region P4 and the pair of fifth regions P5 may be connected continuously. In addition, the separability of the pair of fifth regions P5 may be substantially the same. The pair of fifth regions P5 may be located and configured symmetrically with respect to the fourth region P4. Also, the fourth region P4 may be located in the center portion or close to the center portion of the score lines 411, 412, and 413.

The fourth region P4 of the second score line 412 may be formed longer than the fourth region P4 of the third score line 413. Also, the fourth region P4 of the first score line 411 may be formed longer than the fourth region P4 of the second score line 412.

According to this configuration of the present disclosure, the battery cell 200 located at the outer side may be separated or moved more easily than the battery cell 200 located at the inner side. As a result, the plurality of battery cells 200 may be separated or moved in stages or sequentially, and damage to the battery cells 200 may be minimized.

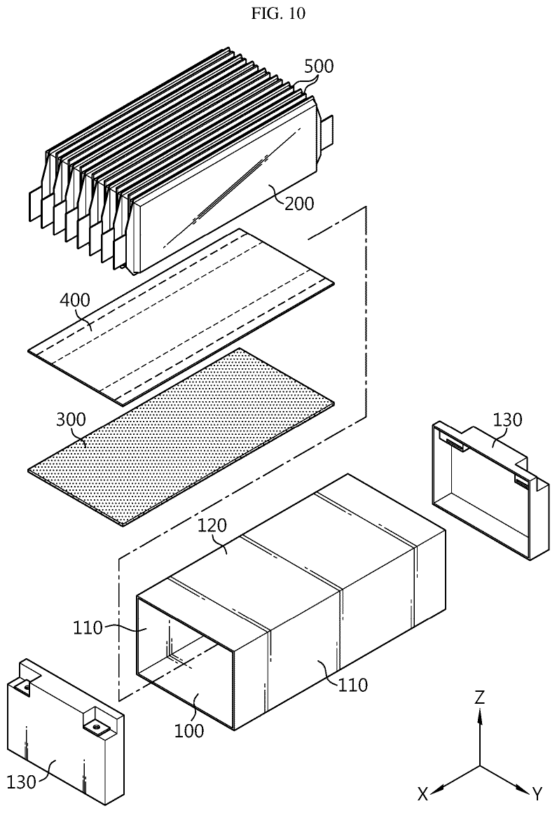

FIG. 9 is a drawing showing a battery module according to an aspect of the present disclosure. Referring to FIG. 9, the base plate 100 of the present disclosure may be configured as the base plate 100 of the battery module. The side plates 110 may be provided at both sides of the base plate 100. The pair of side plates 110 and the base plate 100 may be formed integrally. In addition, the pair of side plates 110 and the base plate 100 may configure a frame. In addition, the top plate 120 may be coupled to the pair of side plates 110. In addition, the end cover 130 may be coupled to the front side and the rear side of the frame, respectively.

FIG. 10 is a drawing showing a battery module according to another aspect of the present disclosure. Referring to FIG. 10, the base plate 100 of the present disclosure may be configured as the base plate 100 of the battery module. The side plates 110 may be provided at both sides of the base plate 100. Also, the top plate 120 may be coupled to the pair of side plates 110. The pair of side plates 110, the base plate 100 and the top plate 120 may be formed integrally. In addition, the pair of side plates 110, the base plate 100 and the top plate 120 may form a frame. Also, the end cover 130 may be coupled to the front side and the rear side of the frame, respectively.

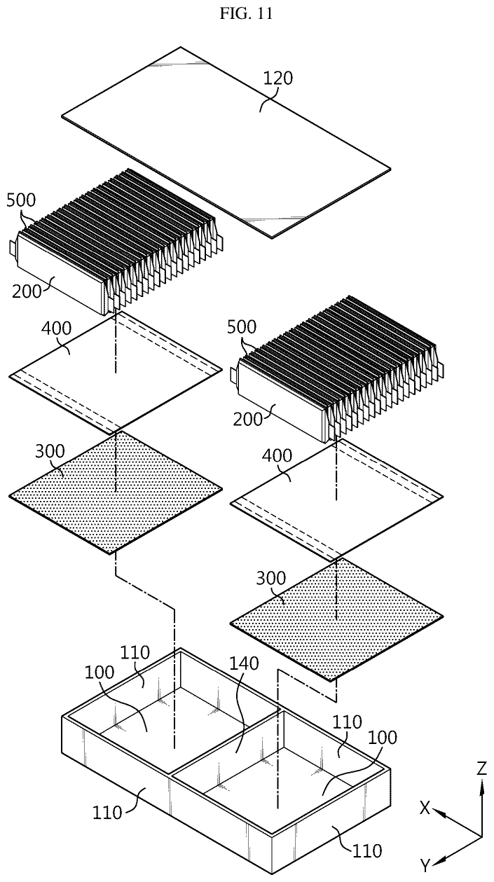

FIG. 11 is a drawing showing a battery pack according to an aspect of the present disclosure. Referring to FIG. 11, the base plate 100 of the present disclosure may be configured as the base plate 100 of the battery pack. The side plates 110 may be provided along the periphery of the base plate 100. Four side plates 110 may be coupled to the upper surface of the base plate 100. At this time, the side plates 110 may be referred to as side walls 110. Also, the top plate 120 may be coupled to the four side plates 110. At this time, the top plate 120 may be referred to as a pack cover 120. Also, the plurality of battery cells 200 may be accommodated in the space formed by the top plate 120 and the side plates 110 without a separate case.

The partition wall 140 may be installed on the upper surface of the base plate 100. Also, the partition wall 140 may be coupled or fastened to the side plate 110. The partition wall 140 may partition the plurality of battery cells 200 into a plurality of groups.

The battery assembly of the present disclosure may mean a battery module or a battery pack. When the battery assembly means a battery module, the battery assembly may further include various components, for example components of a battery module known at the time of filing of this application, such as a module case, a cooling unit, and the like.

In addition, when the battery assembly means a battery pack, the battery assembly according to the present disclosure may further include various components, for example components of the battery pack known at the time of filing of this application, such as a BMS, a bus bar, a relay, a current sensor, etc.

A vehicle according to the present disclosure may include the battery assembly according to the present disclosure described above. The battery assembly according to the present disclosure may be applied to vehicles such as electric vehicles or hybrid vehicles. In addition, the vehicle according to the present disclosure may further include various other components included in a vehicle, such as a body, a motor, and a control device like an ECU (electronic control unit), in addition to the battery assembly.

The terms indicating directions such as upper, lower, left, right, front and rear are used for convenience of description, but it is obvious to those skilled in the art that the terms may change depending on the position of the stated element or an observer.

The present disclosure has been described in detail. However, it should be understood that the detailed description and specific examples, while indicating aspects of the disclosure, are given by way of illustration only, since various changes and modifications within the scope of the disclosure will become apparent to those skilled in the art from this detailed description.

### Reference Signs

100: base plate
110: side plate
120: top plate
130: end cover
140: partition wall
200: battery cell
300: resin layer
400: insulating sheet
410: score line
411: first score line
412: second score line
500: pad

1. A battery assembly comprising:
a base plate;
a resin layer disposed on an upper surface of the base plate;
a battery cell located above the resin layer; and
an insulating sheet located between the battery cell and the resin layer, the insulating sheet having a score line.

2. The battery assembly according to claim 1,
wherein the battery cell is coupled to the insulating sheet.

3. The battery assembly according to claim 2,
wherein a coupling force of the battery cell and the insulating sheet is higher than a coupling force of the resin layer and the insulating sheet.

4. The battery assembly according to claim 2,
wherein the score line is located outside an area where the battery cell contacts the insulating sheet.

5. The battery assembly according to claim 1,
wherein the battery cell extends in an extension direction, and
wherein the score line extends along the extension direction of the battery cell.

6. The battery assembly according to claim 1,
wherein the score line includes:
a first region; and
a second region having higher separability than the first region.

7. The battery assembly according to claim 6,
wherein the score line further includes a third region having lower separability than the second region, and
wherein the second region is located between the first region and the third region.

8. The battery assembly according to claim 1,
wherein the battery assembly comprises a plurality of battery cells and the plurality of battery cells are stacked along one direction, and
wherein the score line extends between two portions of the insulating sheet where two neighboring battery cells among the plurality of battery cells are in contact with the insulating sheet.

9. The battery assembly according to claim 1,
wherein the score line includes:
a first score line extending along one direction; and
a second score line opposite to the first score line,
wherein the first score line is configured to have higher separability than the second score line.

10. The battery assembly according to claim 9,
wherein the second score line is located closer to a center portion of the insulating sheet than the first score line.

11. A battery module, comprising the battery assembly according to claim 1.

12. A battery pack, comprising the battery assembly according to claim 1.

13. A vehicle, comprising the battery assembly according to claim 1.
